(19) United States
(12) Patent Application Publication
(10) Pub. No.: US 2025/0374859 A1
(43) Pub. Date: Dec. 11, 2025

(54) Crop Conditioning

(71) Applicant: AGCO Corporation, Duluth, GA (US)

(72) Inventors: Donald Gilles, Hesston, KS (US); Kevin J. Hamilton, Newton, KS (US)

(21) Appl. No.: 19/233,477

(22) Filed: Jun. 10, 2025

Related U.S. Application Data
(60) Provisional application No. 63/658,541, filed on Jun. 11, 2024.

(51) Int. Cl. A01D 82/00

(52) U.S. Cl. CPC A01D 82/00

(57) ABSTRACT

Systems and methods are provided for monitoring operation of a conditioning system of or otherwise associated with an agricultural machine. This includes driving the conditioning system to a control condition associated with an expected displacement associated with one or more components of the conditioning system and determining a determining a measured displacement for those components. The measured displacement is compared with the expected displacement to determine a calibration for a component positioning system of the conditioning system. Operation of the component positioning system can then be controlled in accordance with the determined calibration.

### CROSS-REFERENCE TO RELATED APPLICATIONS

This application claims the benefit of the filing date of U.S. Provisional Patent Application 63/658,541, “Crop Conditioning,” filed Jun. 11, 2024, the entire disclosure of which is incorporated herein by reference.

### FIELD

Embodiments of the present disclosure relate generally to control systems and methods for an agricultural machine or components thereof, and specifically for monitoring and controlling operation of a conditioning system of or otherwise associated with the machine.

### BACKGROUND

An important process in the harvesting or collection of certain crops is the processing or “conditioning” of the material. Typically, for forage crops such as alfalfa and the like, the crop is cut and “conditioned” through application of a mechanical force to the crop material to encourage wilting and drying of the cut material.

Typical conditioning systems may employ conditioning rollers or rolls which are generally in the form of two rotatable rollers displaced from one another defining a “roll gap” therebetween. Through adjustment of the roll gap a level of conditioning applied to crop material passing between the rollers can be adjusted. Specifically, adjusting the roll gap changes the mechanical force applied to passing crop material and hence the level of conditioning applied thereto.

Different crops may require different levels of conditioning. Accordingly, in known arrangements an operator may make a manual adjustment (e.g. a mechanical adjustment using a wrench or the like) to the roll gap prior to a harvesting or cutting operation for a given crop. However, this is time consuming and typically is only done once ahead of the harvesting of a given field or another working environment. As such, it is not usually possible for the operator to account for changing field and/or conditions which may also require different conditioning levels or different conditioning settings for the conditioning system. For example, a higher crop throughput may necessitate different conditioning settings to apply the same desired level of conditioning to the crop material when compared with a low crop throughput. A wetter crop—i.e. one with a higher moisture content—may require an increased level of conditioning when compared with a drier crop.

Further, in systems where a manual adjustment is made prior to a harvesting or cutting operation, it is not possible to monitor whether the manually set roll gap is maintained over the whole harvesting process.

It would therefore be advantageous to provide a system which may assist an operator in controlling operating settings for a conditioning system which overcomes or at least partly mitigates one or more problems associated with known systems.

### BRIEF SUMMARY

In an aspect of the disclosure there is provided a control system for monitoring operation of a conditioning system of or otherwise associated with an agricultural machine, the control system comprising one or more controllers, and being configured to: drive the conditioning system to a control condition associated with an expected displacement associated with one or more components of the conditioning system; receive sensor data indicative of a displacement associated with one or more components of the conditioning system; determine a measured displacement in dependence on the received data; compare the measured displacement with the expected displacement for the component(s); determine a calibration for a component positioning system of the conditioning system in dependence on the comparison; and generate and output one or more control signals for controlling operation of the component positioning system in accordance with the determined calibration.

Advantageously, the present disclosure utilises a comparison of a measured displacement indicative with an expected displacement in a control condition to control operation of a component positioning system. The system may therefore account for slack in the system, wear, debris, temperature, or other factors which may result in the actual displacement for the components of the conditioning system being different to a set or target displacement, e.g. as determined or set by an actuator or the like associated with the component positioning system.

The one or more controllers may collectively comprise an input (e.g. an electronic input) for receiving one or more input signals. The one or more input signals may comprise the sensor data. The one or more controllers may collectively comprise one or more processors (e.g. electronic processors) operable to execute computer readable instructions for controlling operational of the control system, for example, to determine the measured displacement and/or compare the measured displacement with the expected displacement. The one or more processors may be operable to generate one or more control signals for controlling operation of the conditioning system and/or the component positioning system thereof. The one or more processors may be operable to generate one or more control signals for driving the conditioning system to the control condition, and/or for controlling operation of the component positioning system in accordance with the determined calibration. The one or more controllers may collectively comprise an output (e.g. an electronic output) for outputting the one or more control signals.

The control condition may correspond to an expected displacement which comprises a minimum displacement for the component(s). The control system may be configured to control operation of the component positioning system to drive the component(s) to the minimum displacement. This may comprise application of a tensioning applied by the component positioning system to the component(s) for driving the component(s) to the minimum displacement.

The one or more components of the conditioning system may comprise one or more conditioning rollers. The one or more components of the conditioning system may comprise a pair of conditioning rollers.

The measured displacement may comprise a roller gap. This may be a distance between conditioning rollers of the conditioning system. The control condition may correspond to an expected displacement which comprises a minimum roller gap.

The sensor data may be received from one or more sensors mounted or otherwise coupled in association with the conditioning system for monitoring one or more parameters associated with the operation of the conditioning system. The one or more sensors may be configured to monitor one or more parameters independent from the component positioning system operation, e.g. an actuator position of the component positioning system. The one or more sensors may include a rotary potentiometer providing a comparable sensor output in dependence on the position of the one or more components of the conditioning system itself.

The measured displacement may be determined through comparison of the received sensor data with a base value corresponding to a known displacement. This may be determined, e.g. during manufacture or during an initial setup process. This may comprise driving the conditioning system to a “zero displacement” condition and analysing the sensor output in that condition to determine the base value. The base value for the sensor data may be stored in a memory means accessible by the control system.

The determined calibration may include an adjustment value or offset for the component positioning system. This may include an offset to be applied upon future control of an actuating member of the component positioning system for achieving a target displacement. Additionally or alternatively this may include an offset to be applied upon future control of a level of tensioning applied by the component positioning system, e.g. to achieve a given target displacement.

For example, the component positioning system may comprise one or more actuators for controlling the displacement of the component(s). This may be referred to herein as a gap setting mechanism, or similar. The one or more actuators may form part of a fluid (e.g. hydraulic or pneumatic) drive control system. The one or more controllers may be configured to apply an adjustment a control pressure associated with the fluid drive control system of the component positioning system in dependence on the determined calibration.

In further embodiments the component positioning system may control a level of tensioning applied to the one or more components. The one or more controllers may be configured to adjust a level of tensioning applied by the component positioning system in dependence on the determined calibration. For example, adjusting the control pressure may include increasing a pressure level where the measured displacement is greater than the expected displacement. In turn, this may increase a level of tensioning applied by the component positioning system to the one or more components, which may in turn account for slack or other conditions and drive the components towards the expect displacement (in the control condition) or towards a target displacement (in operating conditions).

The determined calibration may additionally comprise a calibration for one or more further components of the conditioning system. This may be applied, in use, to adjust one or more further operating parameters of the conditioning system in accordance with the calibration, e.g. to achieve a desired level of conditioning where the target displacement cannot be achieved following application of the determined calibration for the component positioning system. The one or more operating parameters may include an operational speed of one or more components associated with the conditioning system. This could include controlling an operational speed of one or more conditioning rollers of the conditioning system.

The calibration may be stored in a memory accessible by the one or more controllers. The memory may be local to the one or more controllers or may comprise a remote memory, such as a remote or cloud based server. Advantageously, the control system may be communicable with the remote or cloud based server over a wireless communication network. This may also enable the memory to be accessible by additional devices, such as a remote user device.

The control system may be configured to automatically control operation of the component positioning system directly. In further embodiments, the control system may be configured to control operation of a user interface for displaying a graphical representation of the calibration, or a noted discrepancy between the expected displacement and the measured displacement, e.g. for keeping the operator informed of the control system operation. The user interface, where present, may comprise a user device, e.g. a phone, tablet computer or the like carried by an operator of the machine and communicably linked to the one or more controllers, e.g. over a wireless communications network. In other embodiments, the user interface may comprise a display terminal of the agricultural machine, for example.

A further aspect of the disclosure provides a conditioning system for an agricultural machine, comprising: one or more moveable crop engaging components; a component positioning system; and the control system of any preceding aspect, operable in use for controlling operation of the component positioning system in accordance with the determined calibration, as determined through comparison of a measured displacement with an expected displacement for the conditioning system in the control condition.

Another aspect provides an agricultural machine comprising the conditioning system and/or comprising or being controllable under operation of the control system of any preceding aspect.

The agricultural machine may comprise a self-propelled machine having the conditioning system forming part of the machine. The agricultural machine may comprise a baler, mower, harvester, or windrower, for example.

In other embodiments, the agricultural machine may comprise a vehicle-implement combination. For example, the machine may comprise a tractor or other vehicle with the implement operably coupled (e.g. towed) thereto. The conditioning system may be provided as part of the implement, and its operation may be controlled by the control system which may, in embodiments be hosted on the vehicle or the implement or distributed across both the vehicle and the implement.

A further aspect of the disclosure provides a computer implemented method for monitoring operation of a conditioning system of or otherwise associated with an agricultural machine, the method comprising: driving the conditioning system to a control condition associated with an expected displacement associated with one or more components of the conditioning system; receiving sensor data indicative of a displacement associated with one or more components of the conditioning system; determining a measured displacement in dependence on the received data; comparing the measured displacement with the expected displacement for the component(s); determining a calibration for a component positioning system of the conditioning system in dependence on the comparison; and controlling operation of the component positioning system in accordance with the determined calibration.

The method may comprise performance of one or more operational tasks performable by the one or more controllers of a control system described herein.

A further aspect provides computer software comprising computer readable instructions which, when executed, cause performance of any method described herein.

A yet further aspect provides a non-transitory computer readable storage medium comprising the computer software of any+preceding aspect.

Within the scope of this application it should be understood that the various aspects, embodiments, examples, and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the disclosure will now be described, by way of example only, with reference to the accompanying drawings, in which:

FIG. 1 is a perspective view of an agricultural machine embodying aspects of the present disclosure;

FIG. 2 is a schematic illustration of the agricultural machine shown in FIG. 1; and

FIG. 3 is a schematic illustration of a control system of the present disclosure.

### DETAILED DESCRIPTION

The present disclosure relates to systems and methods for monitoring and controlling operation a conditioning system 28 of or otherwise associated with an agricultural machine, illustrated herein in the form of as a mower conditioner 10. Sensor data is received from sensors (e.g. sensor 52) operably coupled to one or more components, here conditioning rollers 36, of the conditioning system 28, the sensor data being indicative of a displacement associated with the component(s). The system is configured to drive the conditioning system 28 to a control condition which is associated with an expected displacement of one or more components of the system, specifically here in this example one or more of the conditioning rollers 36. The system utilises the sensor 52 to obtain a measured displacement of the conditioning roller(s) 36 in the control condition, and this measured displacement is compared with the expected displacement for the component(s). Such a comparison is used to generate a calibration for a component positioning system, here a gap setting mechanism 40 associated with the component positioning system, the calibration being used in the controlling of the position of the roller(s) 36 and ultimately a level of conditioning applied to cut crop material passing through the rollers 36. Advantageously, driving the conditioning system to the control condition with a known (or at least expected) displacement may drive any slack out of the system, and obtain (e.g.) an offset between the true displacement associated with the conditioning system component(s) and the desired displacement. In turn, a more accurate conditioning level can be achieved which accounts for, e.g. slack in the system, debris, temperature fluctuations and the like which may otherwise affect the component displacement.

### Agricultural Machine

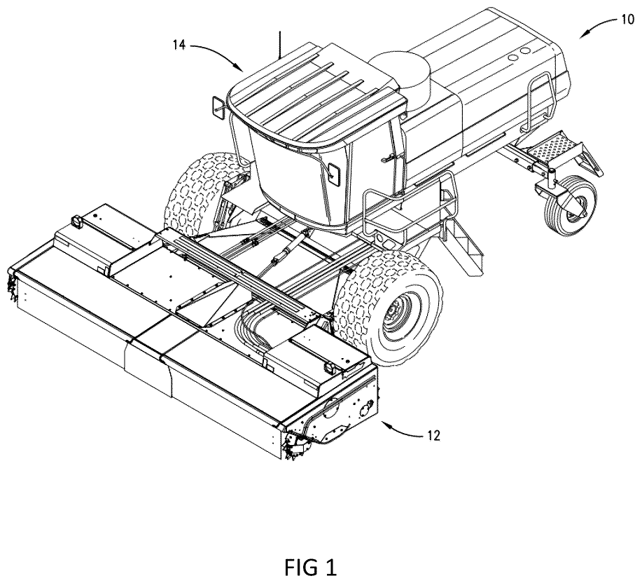

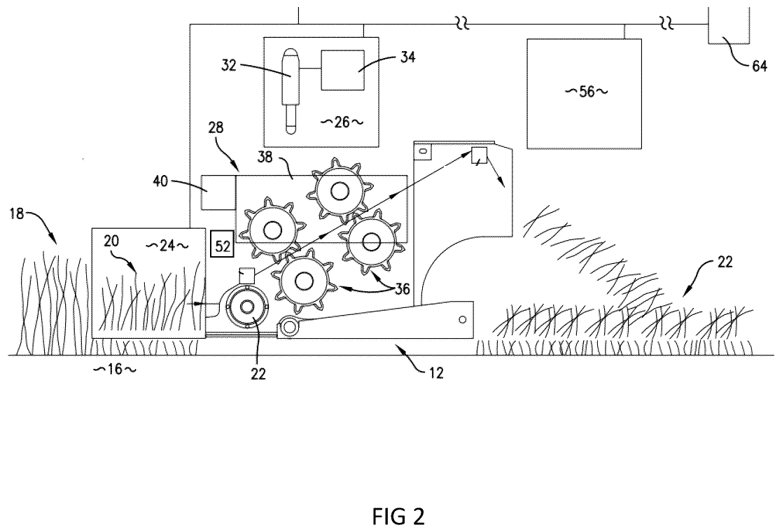

Referring to FIGS. 1 and 2, an exemplary agricultural machine in the form of a mower conditioner 10 (also referred to herein interchangeably as a “mower”) is illustrated. The illustrated mower conditioner 10 is self-propelled and includes a header 12 coupled the front thereof for cutting crop material, as will be appreciated. Specifically, the header 12 is moved over a field 16 of standing crop material 18, used to cut the crop material from the ground, condition the cut crop material 20 as it passes rearwardly through the header 12, and then return the conditioned crop material to the ground in the form of windrows or swathes 22 for drying and subsequent collection.

Referring specifically to FIG. 2, the header 12 includes a crop cutting assembly 24, a lift mechanism 26, and a conditioning system 28. The crop cutting assembly 24 is configured to cut the crop material from the ground. The crop cutting assembly 24 may employ substantially any suitable crop cutting technology, such as a conventional rotary-type cutter bed or a conventional sickle-type cutter bed. Such an arrangement will be readily understood by the skilled reader. Here, a “helper” roller 22 is provided for urging the cut crop material rearward toward the conditioning system 28, however again the skilled reader will appreciate that a number of different configurations may be employed.

The lift mechanism 26 is configured to raise and lower at least the crop cutting assembly 24 to a desired cutting height during operation, and to raise and lower the entire header 12 to, respectively, a non-operational transport height and an operational height. The lift mechanism 26 may employ substantially any suitable lifting technology, such as a hydraulic mechanism or a mechanical mechanism. Again, such an arrangement will be understood. Here, the lift mechanism 26 includes a lift cylinder 32 and a hydraulic lift circuit 34 configured to control the movement of hydraulic fluid to and from the lift cylinder 32 to, respectively, raise and lower the crop-cutting assembly 24 and/or the header 12. In some embodiments, the lift mechanism 26 is provided alongside a tilt mechanism for adjusting a “tilt” or “pitch” of the crop cutting assembly 24.

The conditioning system 28 is configured to receive and condition the cut crop material from the crop cutting assembly 24. The conditioning system 28 may employ substantially any suitable conditioning technology. Here, the conditioning system 28 includes one or more pairs of counter-rotating conditioning rollers 36 configured to “condition” the crop material. That is, as the cut crop material passes between the rollers 36, a mechanical force is applied to the material, crushing, pressing and/or crimping the material to encourage drying of the crop. To enable control over the level of conditioning applied by the rollers 36, a component positioning system in the form of tensioning mechanism 38 is provided. Specifically, the tensioning mechanism 28 is configured to adjustably urge the paired rollers 36 toward one another and resist their separation, and a gap setting mechanism 40 is configured to set an adjustable gap between the paired rollers 36 as will be described in detail hereinbelow.

The conditioning rollers 36 may have relatively non-compressible surfaces made of a hard material, and may take the form of fluted or ribbed steel rollers. Alternatively, the rollers 36 may have relatively compressible surfaces made of rubber or a combination of rubber and steel. Each roller may have a series of radially outwardly projecting ribs that extend along the length of the roller in a helical pattern. The ribs may be spaced around each roller in such a manner that the ribs on one roller intermesh with the ribs of the other paired roller during operation in order to crimp the cut crop material. Alternatively, the rollers may be non-intermeshing in order to crush rather than crimp the cut crop material. It will be appreciated here that the present disclosure is not limited in the construction of the roller surface, and this description is provided by way of example only.

Each pair of conditioning rollers 36 may be mounted in such a way that the one roller 36 is moveable toward and away from the other paired roller 36, while the position of the latter remains fixed. Alternatively, both rollers may be moveable toward and away from each other. Again, the present disclosure is not limited in this sense. Rather, it is simply required that the displacement or gap between the rollers be adjustable.

The tensioning mechanism 38 is configured to adjust a force on one or both of the paired rollers 36 to urge the rollers together to an extent permitted by the gap setting mechanism 40 which sets a running gap between or “displacement” of each pair of rollers 36. The tensioning mechanism 38 may employ substantially any suitable technology, such as hydraulic tensioning technology or spring tensioning technology. In the present embodiment, a hydraulic actuator is employed, which may be utilised by the control system 100 (described in detail below) is configured at least in part to control a hydraulic pressure associated with the tensioning mechanism 38.

The present system further employs a sensing system, here in the form of sensor 52 operably coupled to one of the conditioner rollers 36 for obtaining a measure of a displacement associated with the roller 36. Sensor 52 takes the form of a rotary potentiometer providing a comparable voltage output which is proportional to the position of the roller 36. By utilising a base or control measurement/voltage for a known position—e.g. fully closed—the displacement or position of roller 36 can be inferred from the voltage output of sensor 52. Alternative sensing equipment may be used, as will be appreciated by the skilled reader. For instance, the sensor may include a rotary or angular sensor having a current output or CAN based output, a non-contact sensor such as a hall effect sensor or the like, again with any means of readable output, or a sliding or linear sensor for monitoring roller position/displacement.

### Operational Use

As described, in use crop material 18 is cut from the field utilising crop cutting assembly 24. The cut crop material is passed via one or more rollers, including conditioning rollers 36 to condition the material through application of an appropriate mechanical force to crush or crimp the material to encourage, amongst other things, adequate drying of the crop when placed in a swath behind the machine. Adequate drying may relate to an overall moisture content for the crop, and/or a uniformity of the drying rate across different crop components, for example, between stems and leaves of a crop (e.g. alfalfa crop).

To adjust the level of conditioning applied by the conditioning system 28, gap setting mechanism 40 is used to set a target operating gap or “target displacement” for the conditioning system 28, here that being the operational gap between each of a pair of conditioning rollers 36. As discussed, this may be preset, it may be adjustable manually by an operator e.g. through mechanical interaction with the gap setting mechanism 40 utilising appropriate tooling, or in some instances through input of a desired or target gap utilising, for example, a user interface 56 provided as part of the mower 10. The desired displacement may be dependent on a number of factors, including crop type, crop conditions, field conditions and the like, as will be appreciated. The starting position of the rollers 36 is then set according to this gap.

Over time, mechanical wear, temperature fluctuations, presence of debris etc. may result in the actual displacement of the conditioning system 28 differing from that “set” by the system, e.g. as inferred through piston or other position associated with the gap setting mechanism 40. Accordingly, there is a need to adjust the gap setting mechanism 40 or components thereof periodically to bring the actual displacement of the conditioning system 28 into line with the set/target displacement. This may be time consuming where the system needs to be adjusted manually.

Accordingly, the present disclosure relates to an arrangement where the conditioning system 28 is driven to a control condition. This may correspond, for example, to a minimum roller gap condition, e.g. where the conditioning rollers 36 are at their minimum possible displacement. This may be with the rollers together, or at some minimum gap. In this configuration, a measured displacement is determined, corresponding to the actual position of one or more of the rollers 36 utilizing the sensor 52 in the manner discussed herein. The measured is compared with an expected displacement at the control condition, e.g. the expected minimum roll gap for the conditioning rollers 36. The difference between these two is then used to determine a calibration to be applied in operation of the component positioning system, e.g. hap setting mechanism 40. This may include information as to the offset between the measured gap and the expected gap.

In further variants, operation of the tensioning mechanism 38 may be controlled in accordance with the determined calibration. For example, the effect of an offset in expected vs measured displacement on the overall level of conditioning applied by the conditioning system 28 could be overcome or at least partly addressed through increased tensioning applied by the tensioning mechanism 38.

Additionally or alternatively other operational parameters may be controlled, which may include an operating speed of the conditioning system 28, for example. This could include a roller speed, for example. Again, the effect of an offset in expected vs measured displacement on the overall level of conditioning applied by the conditioning system 28 could be overcome or at least partly addressed through changing a roller speed to have the crop move more quickly or more slowly through the conditioning system 28.

### Control System

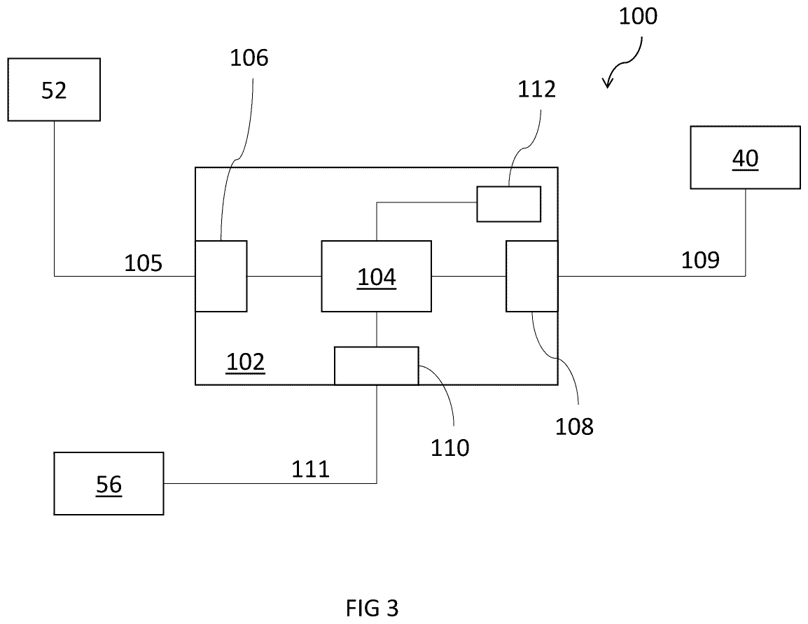

FIG. 3 illustrates system 100 of the present disclosure further. As shown, the system incorporates a control system 100 here having a single controller 102. The controller 102 includes an electronic processor 104, an electronic input 106 and electronic outputs 108, 110. The processor 104 is operable to access a memory 112 of the controller 102 and execute instructions stored therein to perform the steps and functionality of the present disclosure, for example to output control signals 111 via the output 110 for controlling the display terminal 56 of the mower 10, for example to provide an image or graphical representation to an operator of the mower 10 indicative of the measured displacement or other operational steps undertaken by the control system 100.

Output 108 is operably coupled to gap setting mechanism 40. In use, the controller 102 is operable to control operation of the gap setting mechanism 40, specifically through generation and output of control signals 109 for driving the conditioning system 28, and specifically here the conditioner rollers 36 to a control condition. This corresponds to a expected displacement, here roller gap, for the rollers 36. As discussed herein, the gap setting mechanism 40 is operable to control the position of one or more of the rollers 36 through suitable operation of a linear actuator or the like, as will be appreciated.

Whilst in the control condition, and optionally at other times, the processor 104 is operable to receive sensor data via input 106 which, in the illustrated embodiment, takes the form of input signals 105 received from sensor 52. As described in detail herein, the sensor 52 comprises a rotary potentiometer (although other sensing types will be apparent), with the sensor output comprising a voltage output indicative of the position or displacement of an associated conditioning roller 36. The processor 104 is operable to process the voltage output of the sensor 52 to determine a measure of the displacement and utilise this in controlling operation of the component positioning system of the conditioner components (e.g. rollers 36) based on a determined calibration, as described herein.

The determined calibration may subsequently be applied during “normal” operation of the conditioning system 28, e.g. through further control of the gap setting mechanism 40 by the controller 102 and appropriate control signals 109 generated and output thereby. The gap setting mechanism may be controlled in dependence on a calibration which applies an offset to the actuator position control e.g. associated with a corresponding offset between the expected and measured displacement of the rollers 36 in the control condition. The gap setting mechanism 40 may in turn be configured to control a level of tensioning applied by tensioning members 38 thereof in accordance with the calibration.

Output 110 is operably coupled to a display terminal 56 of the mower 10. Here, the control system 100 is operable to control operation of the display terminal 56, e.g. through output of control signals 111 in order to display operational data to an operator of the mower 10 relating to the operation of the control system 100. Specifically, the control system 100 may be operable to control the display terminal 56 to display to the operator a graphical representation the roller displacement, or other useful information including notification of an adjustment being made for information purposes. In some variants, the display terminal 56 may also be operable to receive a user input from the operator, and in such instances the output 110 may act as an input for receiving that user input at the processor 104. The user input may relate to a request to calibrate the system, a requested or desired target displacement for the conditioning system 28. This could include the operator setting a displacement directly, or inputting other information, e.g. crop type, expected moisture level etc. from which the target displacement is determined. As will be appreciated, further displays or user interfaces may be provided for providing operational details to the operator. This could include an interface provided on or proximal to the header or crop intake of the mower itself. This may be used to provide information relating to the desired or based roller displacement as is discussed herein.

### Alternative Embodiments

In a further variant, the control system 100 may additionally be operable to control an operational speed of one or more components of the conditioning system 28 in accordance with the determined calibration. This could include controlling an operational speed of one or more conditioning rollers 36 of the conditioning system 28. In the illustrated embodiments, the control system 100 may be communicably coupled with speed controller 64 of the conditioning system 28 which is operable to control an operational speed of the rollers 36, e.g. a rotational speed thereof.

In alternative arrangements, display terminal 56 may instead be replaced or supplemented by a user device, e.g. a remote or portable user device which is communicably coupled with the control system 100. This may enable the operator to utilize a mobile phone or tablet computer, for example, to control operation of the control system 100, e.g. by inputting desired operational parameters including the target displacement via the user device.

Whilst described herein in relation to a mower conditioner 10, the skilled reader will appreciate that the described solution may be applied to any number of self-propelled agricultural machines which utilise conditioning equipment for the conditioning of crop material, such as forage crops. This may extend to balers, other mowers, harvesting equipment and the like. This may additionally extend to implements for performance of the same task, which are coupleable to other vehicles, including tractors and the like. Where hosted on an implement rather than a self-propelled machine, the control aspects may in some instances be provided locally, or be provided by the towing or coupled vehicle, and a suitable communication link between the vehicle and the implement may be established to enable control of operable components of the implement from the vehicle, and vice versa.

### General

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It will be appreciated that embodiments of the present disclosure can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device, or integrated circuits or on an optically or magnetically readable medium such as, for example, a CD, DVD, magnetic disk, or magnetic tape. It will be appreciated that the storage devices and storage media are embodiments of machine-readable storage that are suitable for storing a program or programs that, when executed, implement embodiments of the present disclosure. Accordingly, embodiments provide a program comprising code for implementing a system or method as set out herein and a machine readable storage storing such a program. Still further, embodiments of the present disclosure may be conveyed electronically via any medium such as a communication signal carried over a wired or wireless connection and embodiments suitably encompass the same.

All references cited herein are incorporated herein in their entireties. If there is a conflict between definitions herein and in an incorporated reference, the definition herein shall control.

What is claimed is:

1. A control system for monitoring operation of a conditioning system of or otherwise associated with an agricultural machine, the control system comprising one or more controllers, and being configured to:
drive the conditioning system to a control condition associated with an expected displacement associated with one or more components of the conditioning system;
receive sensor data indicative of a displacement associated with one or more components of the conditioning system;
determine a measured displacement in dependence on the received data;
compare the measured displacement with the expected displacement for the component(s);
determine a calibration for a component positioning system of the conditioning system in dependence on the comparison; and
generate and output one or more control signals for controlling operation of the component positioning system in accordance with the determined calibration.

2. A control system of claim 1, wherein the control condition corresponds to an expected displacement which comprises a minimum displacement for the component(s).

3. A control system of claim 1, wherein the one or more components of the conditioning system comprises a pair of conditioning rollers; and wherein the measured displacement comprises a roller gap.

4. A control system of claim 3, wherein the control condition corresponds to an expected displacement which comprises a minimum roller gap.

5. A control system of claim 1, wherein the sensor data is received from one or more sensors mounted or otherwise coupled in association with the conditioning system for monitoring one or more parameters associated with the operation of the conditioning system; the one or more sensors being configured to monitor one or more parameters independent from the component positioning system operation.

6. A control system of claim 1, wherein the determined calibration includes an adjustment value or offset for the component positioning system.

7. A control system of claim 6, wherein the component positioning system comprises one or more actuators for controlling the displacement of the component(s), the actuator(s) forming part of a fluid drive control system; and wherein the one or more controllers are configured to apply an adjustment a control pressure associated with the fluid drive control system of the component positioning system in dependence on the determined calibration.

8. A control system of claim 1, wherein the component positioning system controls a level of tensioning applied to the one or more components; and wherein the one or more controllers are configured to adjust a level of tensioning applied by the component positioning system in dependence on the determined calibration.

9. A control system of claim 1, wherein the determined calibration comprises a calibration for one or more further components of the conditioning system, which is applied, in use, to adjust one or more further operating parameters of the conditioning system in accordance with the calibration.

10. A control system of claim 9, wherein the one or more operating parameters include an operational speed of one or more conditioning rollers of the conditioning system.

11. A conditioning system for an agricultural machine, comprising: one or more moveable crop engaging components; a component positioning system; and the control system of any preceding claim, operable in use for controlling operation of the component positioning system in accordance with the determined calibration, as determined through comparison of a measured displacement with an expected displacement for the conditioning system in the control condition.

12. An agricultural machine comprising the conditioning system of claim 11.

13. An agricultural machine comprising or being controllable under operation of the control system of claim 1.

14. A computer implemented method for monitoring operation of a conditioning system of or otherwise associated with an agricultural machine, the method comprising:
driving the conditioning system to a control condition associated with an expected displacement associated with one or more components of the conditioning system;
receiving sensor data indicative of a displacement associated with one or more components of the conditioning system;
determining a measured displacement in dependence on the received data;
comparing the measured displacement with the expected displacement for the component(s);
determining a calibration for a component positioning system of the conditioning system in dependence on the comparison; and
controlling operation of the component positioning system in accordance with the determined calibration.
